(19) United States
(12) Patent Application Publication
(10) Pub. No.: US 2026/0172483 A1
(43) Pub. Date: Jun. 18, 2026

(54) ENHANCED GEOSPATIAL DATA RESOLVER

(71) Applicant: Stripe, Inc., South San Francisco, CA (US)

(72) Inventors: Danko Komlen, Dublin (IE); David Wischhusen, Middleton, WI (US); Erich Rentz, Norwich, VT (US); Techit Limtiyakul, Seattle, WA (US); Bo Li, Jersey City, NJ (US)

(21) Appl. No.: 18/979,307

(22) Filed: Dec. 12, 2024

(51) Int. Cl. H04L 67/52

(52) U.S. Cl. CPC H04L 67/52

(57) ABSTRACT

A server computer system receives handles a client request. The system determines a set of geographical coordinates associated with the request, and uses this coordinates as input into a traversable tree to determine a polygon identifier. The polygon identifier uniquely corresponds to and identifies one of second set of polygons that are non-overlapping versions of first set of polygons that are overlapping. The server computing system transmits a set of parameters that are associated with the one of the second set of polygons that corresponds to the polygon identifier retrieved through the traversable tree.

### BACKGROUND

Data processing systems may comprise one or more computing devices that are connected over a wired and/or wireless communication medium. This medium, the communication protocols used by the various computing devices, and intermediate devices, may be referred to as a computer network. A data processing systems may act as a server which determines, retains, and transmits data electronically over the computer network to a client. A server may have a variety of real-world applications which may interact with other servers, or serve as an endpoint that interacts with human users. These applications are numerous in type and scope, and may include operations related to controlling machinery, transportation, detecting weather, telecommunications, cellular networks, maintaining records, artificial intelligence, facilitating transactions, and more.

Data processing systems may be connected over a computer network for transmitting and sharing information. Computing devices connected to a computer network may include mobile devices, machinery, industrial equipment, household equipment, medical equipment, home computers, web servers, file servers, and more. A computer network may include network-specific devices such as routers, switches, firewalls, and more. The network may include any combination of wired transmission channels (e.g., fiber optic or traditional wire cables) and wireless channels (e.g., electromagnetic transmissions over frequency).

Data processing systems may store and transmit data associated with geographic areas. Such data may change over time, or boundaries of the geographic areas may change, or both. Tracking the change to the geographic areas and the data associated with each area is computationally heavy, especially considering that geographic areas may overlap which may impact overlapping data at a particular location where there is overlap of the areas. When a data processing system acts as a server that responds to client requests for geographic-based data, a low latency response by the server is desirable. This may be especially important in real-time applications, where the client relies on the server to provide the geographic-based data with minimal delay, and uses this data to perform additional actions.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 illustrates a system level diagram of an example geographical-based data processing system, in accordance with an embodiment.

FIG. 2 shows a flow diagram for a geographical data processing system, in accordance with an embodiment.

FIG. 3 shows a flow diagram of a method for serving geographical-based parameters, in accordance with an embodiment.

FIG. 4 illustrates an example of generating non-overlapping second set of polygons based on first set of polygons, in accordance with an embodiment.

FIG. 5 shows an example workflow for updating second set of polygons based on a change to first set of polygons, in accordance with an embodiment.

FIG. 6 is one embodiment of a computer system that may be used to support the systems and operations described, in accordance with an embodiment.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “storing”, “detecting”, “applying”, “transmitting”, “generating”, “decoding”, “configuring”, “building”, “loading”, “updating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Data processing systems may be connected to a computer network, and service requests from other computers over the network. These systems may store and share data with each other. Some may act as a server (e.g., handling a request) and some may serve as a client (e.g., requesting a service). A server may manage data associated with different bounded geographical areas, and handle requests for such data. Given that the data associated with each area may change, or the boundaries of each area may change, tracking geometry of these geographical areas with respect to these changes to the data is a computationally heavy task because of the number of geographic boundaries, boundary types, overlap between boundaries, etc., which make the computation of boundary changes computationally challenging. Furthermore, as the number and complexity of geographic areas for which geographic boundaries are analyzed prior to executing a request, the computational challenge is expanded. The frequency of boundary changes and changes in associated data (e.g., parameter set) is relatively low, compared to frequency of requests served to clients. Clients may also want to do requests at arbitrary associated time and do lookups in the past and future.

For example, geographic area 1 may be associated with weather patterns A, B, and C, while geographic area 2 may be associated with weather patterns B and D. These geographic areas may overlap, meaning that borders of areas intersect. Over time, the geographic area 1 may be redrawn (e.g., through districting, or other reasons). Additionally, or alternatively, the parameters for either geographic area may change from time to time-e.g., the weather patterns for geographic area 1 may change to A, B, and Z. A client may request parameters that are specific to a particular location in an overlapping area of geographic area 1 and geographic area 2. These parameters may be a combination of respective parameters from the two geographic areas. The potential of tracking of hundreds, thousands, or more, of different geographic areas and multiple parameters per area is computationally heavy. Latency may be introduced into the data processing system when responding to a request for a set of parameters for a given address due to the computationally heavy operations that derive geographic areas, determine overlap, and determine parameters for a determined geographic area. Such latency may be unacceptable or severely hamper data processing systems when this data is required immediately (e.g., to perform a time-sensitive task such as operating machinery, servicing a data access request, or completing a requested transaction over a computer network). Clients may request parameters for a specified geographical position and expect these parameters with minimal delay (e.g., within a second or less).

Existing data processing systems (e.g., servers) may struggle with handling such a request with minimal latency, especially if using a brute-force approach to handling each request by computing the respective parameters of a given location at the time of the request. Due to the sheer number of geographic areas and potential overlap, handling such a request and calculating these parameters for a specified location without pre-processing the information associated with each geographical area may cause undesirable latency. Even if this latency is on the order of milliseconds, the total latency experienced by a requesting client can add up when handling a high volume of requests. When a client relies on this information as part of a larger set of operations (e.g., to initiate a mechanical operation, access data, process a transaction, etc.), even a small delay may have a noticeable or unacceptable effect on the overall operation or response of the client. The latency grows further in order to support historical requests, as the server has to work with different versions of geographical areas.

Aspects of the present disclosure address the aforementioned technical challenges and include a data processing system that processes digital files containing polygons representing geographic areas contained in an overall area. Some of these geographic areas may overlap, while others may not. Areas can contain holes and also have disjoint islands. Each of the geographic areas is associated with its own set or parameters, which have different combinations of parameters from one geographic area to another. For example, a parameter set for a first area may be empty, a parameter set for a second area may comprise a set of parameters {A, B, C}, and a parameter set for a third geographic area may comprise {B, D}, where the parameters are used to determine whether and/or how to process a request received from a client device.

In embodiments, the system may process these polygons to generate a set of non-overlapping polygons over the same overall area, where each of the non-overlapping areas are associated with a parameter set that accounts for the overlap. For example, where geographic area 1 and geographic area 2 overlapped in the input polygons, a new polygon is generated and the corresponding parameter set for this new polygon is {A, B, C, D}. This process of generating a new non-overlapping set of polygons with corresponding parameter sets is performed ‘offline’, meaning that it is performed before and asynchronously from when it is used to determine whether or how to execute a request of a client device. Each non-overlapping polygon is associated with an identifier (e.g., a polygon ID) that is associated with its unique set of corresponding parameters (e.g., on a one to one basis).

The data processing system generates a traversable tree (e.g., an R tree) using the non-overlapping set of polygons. This traversable tree is built as a data structure where the root represents the overall area, and each node represents a polygon. The tree is built such that when one of the input polygons was originally enclosed in another input polygon, that node representing the enclosed polygon is a child node of the polygon that encloses it. The traversable tree is loaded into memory which is accessible during ‘live’ operation. This second point in time may be referred to as an initialization phase of the request handling engine, such as when the data processing system's engine boots up or comes online. The engine handles requests from clients (e.g., end users, other servers, etc.) through a user interface or application programming interface (API) accessed over a computer network, or both. By building the information into a data structure that increases retrieval speed by the server, latency may be greatly reduced in handling a client request because traversal of the tree to obtain a specific geographic region and associated parameters is computationally efficient. That is, rather than calculating specific geographic areas at the time of a request, the use and traversal of the generated tree in the data structure requires less computational resources. Furthermore, this traversable data structure may be generated and populated at a second point in time that may be separate and decoupled from the generation of new polygons.

When the data processing system receives a request from a client, the data processing system determines coordinates based on the request. For example, if the request includes an address, the data processing system may determine a geographic coordinate (e.g., latitude and longitude, or other geographical coordinate) by accessing one or more geocoding services over the computer network. Once obtained, the data processing system may input the geographic coordinate into the traversable tree to obtain the corresponding polygon ID. The data processing system references the corresponding set of parameters for that polygon ID and transmits this set of parameters over the computer network. This transmission may be sent back to the client or forwarded to a second client, or both.

By creating a non-overlapping second set of polygons and corresponding set of parameters offline, the data processing system is able to perform the heavy processing task of finding every overlapping area and generating combined set of parameters in an offline manner. Further, by generating the traversable tree and loading it into local memory ahead of time, the engine may quickly service a request by finding the corresponding polygon ID and ultimately transmit the parameters to handle the request. Latency is reduced because additional network calls are not performed to determine the corresponding polygon ID or parameter set, which would otherwise be the case for existing technology that relies solely on a geospatial database. Additionally, domain specific optimizations can be done when tree lookup returns multiple polygon candidates. Every candidate has to be intersected with a point (e.g., a geographical coordinate) to find the right candidate, and the order in which these intersections are done will impact the overall lookup performance. In an embodiment, in response to when a tree lookup returns multiple polygon candidates, the system may select a first of the multiple polygon candidates and based on one or more selection rules (e.g., proximity of the polygon candidate to the point, size, etc.), and then intersect the candidate with the point to determine if the candidate is overlaid on the point. If so, the polygon ID associated with this candidate may be returned, and if not, then the system may select a second of the multiple polygon candidates based on the selection rules, and so on, until the candidate that overlays the point is found.

Other technical features may be readily apparent to one skilled in the art from the following figures, descriptions, and claims.

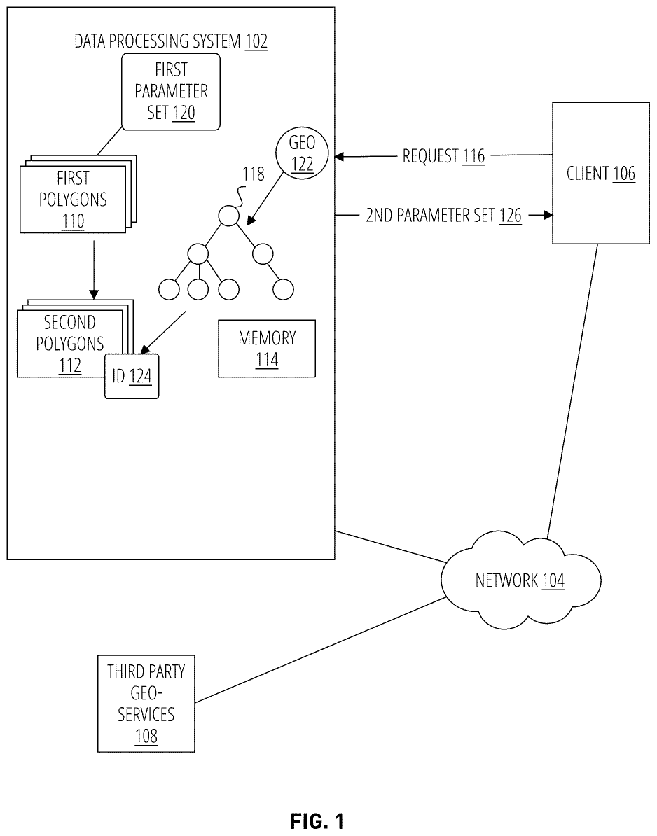

FIG. 1 illustrates a system level diagram of an example geographical-based data processing system 102, in accordance with an embodiment. The diagram is an exemplary data processing system, and can be used to implement other sections where some of the aspects and embodiments are described in further detail.

Data processing system 102 may include one or more server computer systems configured to service client requests for a specified geographic area. Data processing system 102 may comprise one or more processors and other components associated with computing systems. Furthermore, data processing system 102 can include computer executable instructions stored in memory 114. In an embodiment, the data processing system 102 may comprise a monolithic architecture. In another embodiment, the data processing system 102 may be a distributed architecture including instances of the data processing system 102 distributed among several computer systems.

In any of the embodiments, the data processing system 102 may comprise multiple services or separate applications, which may reside on a single computer system or across multiple nodes on a computer network 104. The services or applications may operate independent of each other, and communicate with each other or perform related operations that provide the described functionality.

Data processing system 102 may be in communication with a computer network 104 through a computer communication protocol (e.g., TCP/IP, etc.). Computer network 104 may comprise a plurality of network nodes which are computing devices such as clients, servers, databases, mobile devices, internet of things (IoT) devices, etc., that are communicatively coupled through wired or wireless communication channels.

In embodiments, data processing system 102 may obtain first set of polygons 110. Each of the first set of polygons 110 may correspond to a real world geographic location bounded by the polygon, and further may be associated with a corresponding one of first set of parameter sets 120. Data processing system 102 may combine any number of first set of polygons 110 to generate second set of polygons 112. For example, first set of polygons 110 may comprise various overlapping geographic areas (e.g., different cities, counties, states, towns, school districts, ecosystems, environments, utility coverage areas, cells of a cellular network, etc.). The corresponding first set of parameter set 120 may comprise parameters specific to one of the first set of polygons 110, such as controls placed on a requested operation, subsequent operations that should be performed in response to a requested operation, denying a requested operation that is not allowed for a geographic location, etc.

Data processing system may combine the first set of polygons 110 to generate non-overlapping second set of polygons 112. In an embodiment, none of second set of polygons 112 overlap, while the first set of polygons can have an arbitrary number of overlapping regions. In an embodiment, at least two or more of the first set of polygons 110 have overlap. In an embodiment, at least one polygon of the first set of polygons is disjoint (e.g., having one or more disjoint islands), of comprise one or more holes. Furthermore, each of the non-overlapping second set of polygons 112 is associated with a unique identifier, such as ID 124, to differentiate between the different non-overlapping second set of polygons 112. The ID generation algorithm used is deterministic. For the same set of parameters, the data processing system will generate the same unique identifier. This property enables the system to efficiently perform algorithms for assigning valid time windows to the second set of polygons as the system receives and performs updates to the first set of polygons or new parameters get introduced for one or more of the first set of polygons.

For example, first set of polygons 110 may comprise hundreds of polygons, including polygon A and polygon B where polygon A represents boundaries of a rain forest and polygon B represents boundaries of a lizard habitat, and these boundaries have overlap. First set of parameter set 120 for polygon A may comprise a list of environmental rules specific to the rain forest, and corresponding first set of parameter set 120 for polygon B may comprise a second list of environmental rules specific to the lizard habitat, which may be different from that of polygon A. Further, the first set of parameter set 120 for polygon B may have additional data such as predators for the lizards, etc. Data processing system may generate second set of polygons 112 with a first polygon representing where polygon A and polygon B do not overlap, a second polygon representing the overlap of polygon A and polygon B, and a third polygon representing polygon B without overlap. Second set of parameter set 126 may be generated for each of second set of polygons 112.

For example, the second set of parameter set 126 that corresponds to the second polygon 112 at the region of overlap between polygon A and polygon B may comprise environmental rules for the lizard habitat and for the rainforest, as well as the predator information associated with the lizard habitat. In another example, each of first set of polygons 110 may be associated with a first set of parameter set 120 that includes tax rules specific to that geographic boundary. Second set of parameter set 126 may, as a result of the combining, contain tax rules specific to the geographic boundaries of the second set of parameter set 126. Client 106 may receive the second set of parameter set 126, and apply these tax rules in real time to perform a transaction of goods or services and apply those tax rules specific to the location of the transaction.

Data processing system 102 may generate a traversable tree 118 based on second set of polygons 112 that are non-overlapping. The traversable tree is configured to receive an input geographical coordinate and output a corresponding polygon identifier that is associated with one of the second set of polygons 112 that the geographical coordinate resides in. Data processing system 102 loads the traversable tree 118 in memory 114 which may be local to data processing system 102. Local memory may refer to memory that is directly accessible by data processing system 102 without using the computer network 104. By doing so, latency resulting from accessing the traversable tree may be reduced.

Data processing system 102 receives a request 116 over the network 104 from client 106. In response to receiving the request 116 over the network 104, data processing system 102 determines a geographic coordinate 122 that is associated with the request 116. Data processing system 102 traverses the traversable tree 118 in the memory 114 using as input, the geographical coordinate 116 that is associated with the request. In an embodiment, data processing system 102 may determine the geographic coordinate 122 a geocoding request to third party geo-services 108. The geocoding request may comprise a location (e.g., an address) provided in the request 116. In an embodiment, data processing system 102 may transmit multiple geocoding requests to a plurality of different third party geo-services 108, and verify that these third party geo-services 108 provide the same geographic coordinate 122, as described further in other sections. Also, using multiple geocoding services improves the precision and accuracy of obtaining the location that is associated with the request.

The traversable tree 118 returns a corresponding polygon identifier 124. Each polygon identifier may correspond to exactly one of the second set of polygons 112 (e.g., on a one to one basis). By building the traversable tree 118 ahead of time (e.g., prior to receiving a client request 116), and then traversing the nodes in the traversable tree 118 when the request 116 is received, the data processing system 102 may obtain a corresponding polygon identifier 124, with reduced or minimal latency.

Data processing system 102 may transmit over the network, one of second set of parameter sets 126 associated with one of the second set of polygons 112 that corresponds to the corresponding polygon identifier 124. Depending on the nature of the data (e.g., environmental, access request data, tax-based, cellular networks, etc.), the client may perform different operations with the second set of parameter set 126. For example, the client may request to access data, where the client is located in a first geographic area. In this example, data that may be served to the requesting client may be subject to geographic limitations, such as certain data may not be transmitted to country A when it originates from country B. As another example, the client 106 may facilitate a transaction between a merchant and customer. In such an example, the client may request tax rules specific to a location (e.g., an address) associated with the transaction. The data processing system 102 may, in such an example, determine geographic coordinate 122 that is associated with the request location, and use the traversable tree 118 to obtain a polygon ID 222 associated with the second set of polygons 112 in which the geographic coordinate 122 resides. The data processing system 102 may determine the corresponding second set of parameter set 126 associated with the second polygon 112 that corresponds to that polygon ID 222, and return this to the client 106 so that the client can apply the respective tax rules (e.g., rates) to determine what overall tax rate should be applied to that transaction. In other examples, the data processing system may handle requests for returning second parameters relating to weather, geology, plant or animal species, cellular network coverage, speed limits, zoning laws, or other geography specific data.

Rather than a brute force approach of determining overlapping portions of first set of polygons and then combining each of the first set of parameter sets each time a client transmits a request, the data processing system 102 pre-generates non-overlapping second set of polygons from the first set of polygons, and builds the traversable tree to locate a corresponding polygon, prior to receiving the client request. When the client request is received, the data processing system 102 traverses the tree which provides a single set of the requested second parameters more quickly than the brute force approach, thereby reducing latency of handling the request, so that the client may use this data to complete its own operation (e.g., data access control, cellular network access, completion of a transaction based on the data, transmitting a command to machinery, etc.).

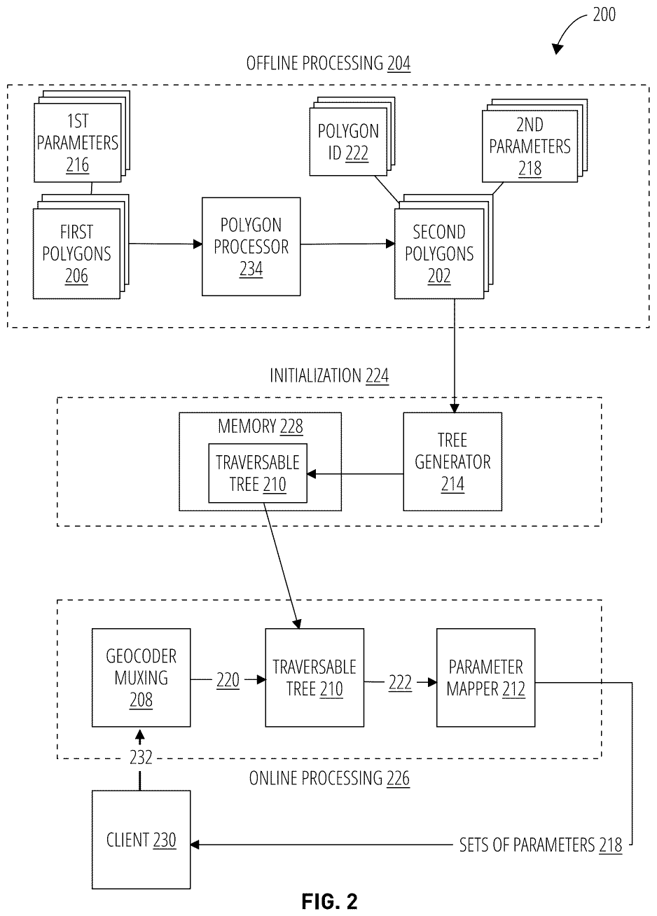

FIG. 2 shows a flow diagram for a geographical data processing system, in accordance with an embodiment. The flow diagram illustrates operations 200 that are performed by a data processing system such as, for example, data processing system 102, at various stages.

During offline processing 204, a data processing system 200 may obtain first set of polygons 206. These may be obtained from user entry, or downloaded from a database or file server, or copied from a file system, or a combination thereof. The polygons, as discussed above, represent boundaries of real world geographic locations. First set of polygons 206 may comprise overlapping polygons. Overlapping polygons may be partially overlapped where two or more polygons share intersecting portions. Overlapping polygons may, under existing systems, cause retrieval of the parameters to be delayed, because a request for corresponding parameters at a certain point of overlap would require the data processing system 200 to first determine that there is overlap at a specified point location, and then combine the parameters of those overlapping polygons to determine the parameters that are associated with that point location. Additionally, or alternatively, one or more polygons may be completely enclosed by another polygon, have holes or disjoint islands, further causing retrieval complexity in existing systems. Each of the first set of polygons 206 may be associated with a respective first set of parameters 216. As discussed herein, the parameters may include conditions, rules, limitations, allowances, or other characteristics associated with the polygon that inform performance of a requested action associated with a polygon in which a requesting client is located.

At polygon processor block 234, the data processing system 200 may decode data files to extract the first set of polygons 206 from those data files. First set of polygons 206 may be extracted out of data files (e.g., GeoJSON files) which may define the shape, size, and location of the first set of polygons 206. In an example, the GeoJSON files also comprise one or more fields that define first parameters 216 for each of the first set of polygons 206. For example, a single GeoJSON file may comprise a single one of first set of polygons 206, and the first set of parameters 216 that correspond to that first polygon.

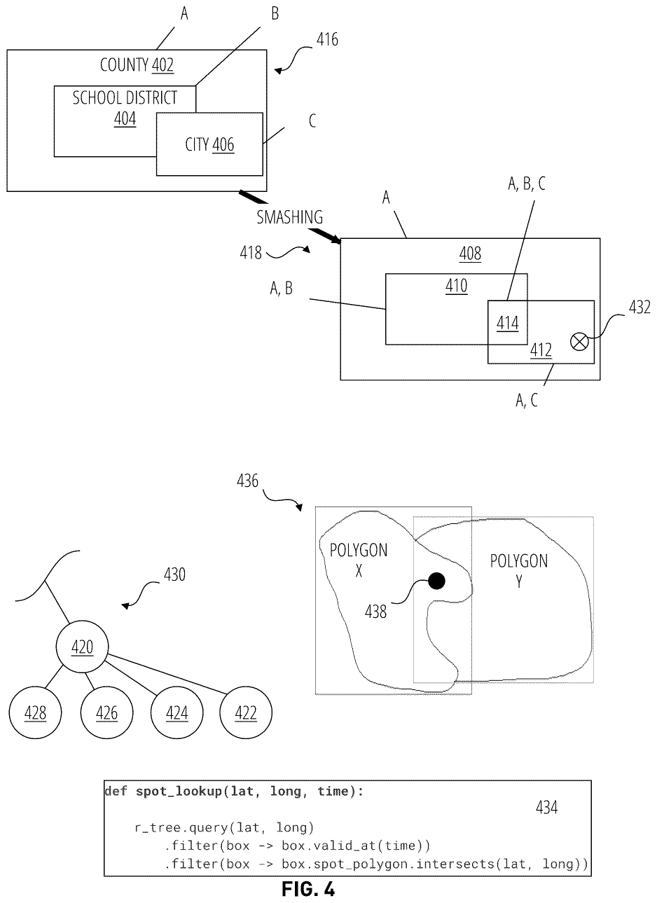

At block 234, the data processing system 200 may align the first set of polygons 206 onto a common reference plane. The common reference plane may be referred as a common spatial reference system or common coordinate reference system such as, for example, a virtual two-dimensional map. In an embodiment, the data processing system 200 may, when aligning the first set of polygons 206, refrain from intersecting disjoint types of polygons in the first set of polygons 206, to account for relationships between those polygons in the first set. Based on the data quality of first set of polygons, data processing system 200 may, in an embodiment, ignore slivers (e.g., based on a threshold geometry) that might be created during the overlapping process. Each of the first set of polygons 206 is placed on the common reference plane based on its size, shape, and location. Two or more of the first set of polygons 206 may overlap and potentially create a new polygon. See, for example, FIG. 4 in which first polygon 404 overlaps first polygon 406, both of which are enclosed in first polygon 402. FIG. 4 is discussed in greater detail below.

Referring back to block 234 of FIG. 2, the data processing system 200 determines each of the second set of polygons 202 based on the superimposed first set of polygons 206. As a result, second set of polygons 202 do not include overlapping polygons, because each of the overlapping portions is generated as its own polygon. The polygon processing block 234 may be referred to as ‘smashing’ or ‘flattening’ the first set of polygons 206, and is discussed in greater detail herein. Flattening algorithm can have a brute force intersect every polygon with every other polygon approach. However, this can be computationally expensive and domain specific optimization, with polygon relationships can be applied. In an embodiment, based on data showing how the first set of polygons is related to each other, the data processing system 200 may determine which types of first set polygons intersect with which other types. For example in the domain of taxing jurisdictions, if city level jurisdictions are disjoint, the data processing system 200 may skip intersections for the disjoint city level jurisdictions, which will reduce the number of polygon intersections that the data processing system 200 is to perform. In addition, each of the second set of polygons 202 comprise a unique polygon ID 222, and a respective second set of parameters 218, which are derived from first set of parameters 216 and first set of polygons 206, such as a union of the parameters of the first set of polygons 206. In an embodiment, each of the second set of polygons 202, and/or the second parameters 218 and/or the polygon ID 222 may also be stored in memory as GeoJSON data files.

In an embodiment, the data processing system 200 may perform offline processing 204 according to an automated schedule (e.g., periodically on a monthly, daily, hourly, or other basis). Additionally, or alternatively, the data processing system may update the second set of polygons 202 in response to a change in shape, size, or location of the first set of polygons 206, such as in response to receiving an updated set of first set of polygons 206. For example, the data processing system may be registered to receive an update from a database comprising first set of polygons 206 or first set of parameters 216. In response to a change to first set of polygons 206 or first set of parameters 216, the data processing system may automatically run the polygon processor block 234 to update second set of polygons 202 and the associated polygon IDs 222 and second set of parameters 218.

In an embodiment, data processing system may perform only an update on the area of change to first set of polygons 206. For example, the data processing system may generate new second set of polygons 202 based only on the areas of first set of polygons 206 that have changed. In such a manner, the data processing system 200 does not recalculate second set of polygons needlessly and computational overhead may be reduced by reducing the number of first set of polygons that are accessed and used to recompute only impacted second set of polygons. Further, the data processing system can store, in memory, the changed first set of polygons 206 and the changed second set of polygons 202, to maintain a digital history of the changes, as described further in other sections.

Initialization 224 may be performed periodically, or once each time the data processing system 200 starts online processing 226 at system start-up of the data processing system, or both. Initialization may refer to loading up of components into memory, provisioning of hardware, etc. In an embodiment, tree generator 214 of the data processing system may generate a traversable tree 210 based on second set of polygons 202. In an embodiment, tree generator 214 generates the traversable tree using a tree building algorithm, such as Nearest-X, Sort-Tile-Recursive (STR) tree, or other bulk-loading tree building algorithm. The tree building algorithm can draw bound boxes around polygons starting with larger bound boxes, to incrementally smaller bound boxes, where each bound box represents a node, and each subsequent bound box within a larger bound box is a branch created from the corresponding node, until all second set of polygons are expressed as leaf nodes in the traversable tree and the resulting traversable tree is balanced. The traversable tree 210 may be configured to receive an input geographical coordinate and output a corresponding polygon identifier that is associated with one of the second set of polygons that the geographical coordinate resides in. The data processing system loads the traversable tree 210 in memory 228, so that it may be accessed by the data processing system during online processing 226.

In an embodiment, the data processing system 200 builds the traversable tree to have a plurality of nodes. Each of the plurality of nodes may correspond to a bound area that bounds at least one of the second set of polygons 202. Nodes of the tree connect through branches. A node from one level branches to one or more nodes of the next level, and so on, until each branch ends at a node without another downstream branch. Such a node can be referred to as a leaf node, and each leaf node may correspond to one of the second set of polygons 202. Branching of the plurality of nodes in the traversable tree is determined based on nesting of the corresponding bound area with respect to other bound areas.

In an embodiment, memory 228 resides locally on the data processing system 200. During the online processing 226 stage, the data processing system 200 may use this traversable tree 210 stored in local memory 114. This reduces latency that may otherwise be caused if the traversable tree 210 was stored in remote memory (e.g., requiring one or more calls or hops on the computer network). Furthermore, storing the traversable tree 210 in local memory enables fast access to the tree via read/access requests issued to the traversable tree 210.

In an embodiment, traversable tree 210 comprises a balanced tree. The data processing system 200 may construct the traversable tree 210 so that a difference in the height of its left and right subtrees is at most one. This balancing limits the worst case latency of traversing the traversable tree. In an example, the traversable tree 210 comprises an R-tree, where each of the bound boxes are rectangular. An R-tree groups nearby objects and represent them with their minimum bounding rectangle in the next higher level of the tree. All objects (e.g., second set of polygons 202) in an R-tree lie within this bounding rectangle. A query to the R-tree that does not intersect the bounding rectangle also cannot intersect any of the contained objects. At a leaf level of the R-tree, each rectangle describes a single object (e.g., a single one of second set of polygons 202). At higher levels the aggregation includes an increasing number of objects.

In an example, the traversable tree 210 may comprise an R-tree or an M-tree, or other balanced traversable tree. An M-tree is similar to an R-tree, except instead of a rectangle, each node corresponds to a circle area that encloses the polygons traversed by that node.

Online processing 226 refers to the data processing system 200 being accessible and responsive to client requests over a computer network. A client 230 may transmit a request 232 to the data processing system. The request 232 may be to obtain parameters (e.g., second set of parameters 218) that are associated with a specified geographic location. The request 232 may comprise an address (e.g., a street address), a zip code, the name of an establishment, or other geographic data. In response to receiving the request 232, the data processing system may, at geocoder muxing block 208, determine a geographical coordinate of the request based on the geographic data.

In an embodiment, data processing system 200 may transmit a geocoding request to a geocoding service over a computer network, to obtain the geographical coordinate 220. For example, the client request 232 may comprise a geographic data such as a physical address (e.g., 123 Maple Lane). Data processing system 200 may transmit a request to a geocoding service (e.g., Smarty, Esri, etc.), requesting a coordinate for 123 Maple Lane. Data processing system 200 may receive, over the computer network, a corresponding geographical coordinate (e.g., −115, 83) for 123 Maple Lane.

In an embodiment, data processing system 200 may request the coordinates 220 from multiple geocoding services. For example, at geocoder muxing block 208, the data processing system 200 may obtain a first geographic coordinate associated with the physical address, by transmitting a request, over a computer network, using a first API and a first internet address. The data processing system 200 may transmit a second request over the computer network using a second API and a second internet address. Each request may be transmitted to a different geocoding service over the computer network. The data processing system 200 may receive responses back from each request and compare a first response (comprising a first geographical coordinate), to a second response associated with the second request, and if they are different, the data processing system 200 may perform a fallback operation. For example, if at block 208, the responses from the different geocoding services do not match, or if both return a blank or error response, data processing system 200 may refer to a ZIP code database that maps each ZIP code to a corresponding geographic coordinate (e.g., latitude and longitude), which may then be mapped to a polygon ID 222 of the second set of polygons 202. In an embodiment, a first geocoding service is designated as a primary geocoding service, and if this fails to return coordinates 220, a fallback or second geocoding service may be used. In an example, the designations of the primary and secondary geocoding service may be configurable (e.g., as a user exposed setting). In an embodiment, the configuration may specify whether to implement such a fallback logic, or alternate between geocoding services, or a combination thereof. In an embodiment, each geocoding service may comprise a third party service provider. This multi-geocoding service architecture improves fault tolerance, while supporting performance tuning, cost optimization and extensibility. Data processing system 200 may leverage multiple geocoding services to improve accuracy while using a fallback operation to still provide some response to client 230.

Data processing system 200 may traverse the traversable tree 210 in the memory 228, using as input, the coordinates 220 that are determined based on the request 232. The traversable tree 210 may be traversed until reaching a leaf node comprising the corresponding polygon identifier 222. In an embodiment, the time complexity to obtain the polygon ID 222 from a traversable tree 210 in big O notation is O(logMn) on average, and O(n) in a worst case. The time complexity to insert a new polygon ID 222 in the traversable tree 210 is O(n) in a worst case. This time complexity is indicative of how using the traversable tree 210 reduces the latency required to respond to parameter requests in real time. In an embodiment, the data processing system may filter the candidate polygons by valid range given the query date, to get only active candidates. The traversable tree 210 may return multiple candidate second polygons, such as, for example, when two disjoint second level polygons have overlapping bounding boxes, due to polygon shapes (as described with respect to FIG. 4). In such a case, the data processing system 200 may perform an intersection with the actual second polygon candidates (e.g., based on the borders and location of the second polygon candidate to see if it encloses the coordinates 220) and query latitude, longitude to find the exact second polygon enclosing those coordinates 220. Every leaf in the traversable tree 210 refers to a single bound box and single second polygon, where that second polygon corresponds to a polygon ID 222.

At parameter mapper 212, the data processing system 200 may perform a reverse lookup of the polygon ID 222, and obtain a respective second set of parameters 218 for the retrieved polygon ID 222. For example, assuming that the polygon ID 222 retrieved for 123 Maple Lane is polygon 101, then data processing system 200 may look up the second sets of parameters 218 that are associated with polygon 101. Data processing system 200 may transmit over the network, the corresponding set of second sets of parameters 218 to the client 230.

In an embodiment, at tree generator block 214, the data processing system 200 may generate each of the plurality of nodes of the traversable tree 210 with a respective expiration time. In an embodiment, when the traversable tree is used to lookup the polygon ID 222, the data processing system 200 may filter the traversable tree to ignore each of the plurality of nodes that are expired according to the expiration time to ensure that returned results are still valid (e.g., not expired).

In an embodiment, each of the stages (e.g., offline processing 204, initialization 224, and online processing 226) may be decoupled from each other and performed according to different schedules or triggering mechanisms. Furthermore, each of the services may be distributed among distributed systems of a data processing system. In embodiments, each of the stages may be performed by respective services or groups of services of a microservices application. In an embodiment, every second polygon corresponds to a unique polygon ID and a valid time window assigned to it (e.g., based on a default time range T1-T2 or configurable settings). In an embodiment, the valid time window is automatically and dynamically determined based on frequency or amount of updates, for example, as the frequency or amount of updates to first polygons increases, the system may decrease the length of the valid time window. Similarly, if the frequency or amount of the updates to the first polygons decreases, the system may increase the length of the valid time window. Same overlapping first polygons will have the same polygon ID. For example, if a district is removed, second polygons that contain that district will be end dated and expired. In the future the same district can be re-introduced in an update, and second polygons with the same polygon IDs will be added with a new valid window, so that second polygons are uniquely identified by polygon ID and the valid time window.

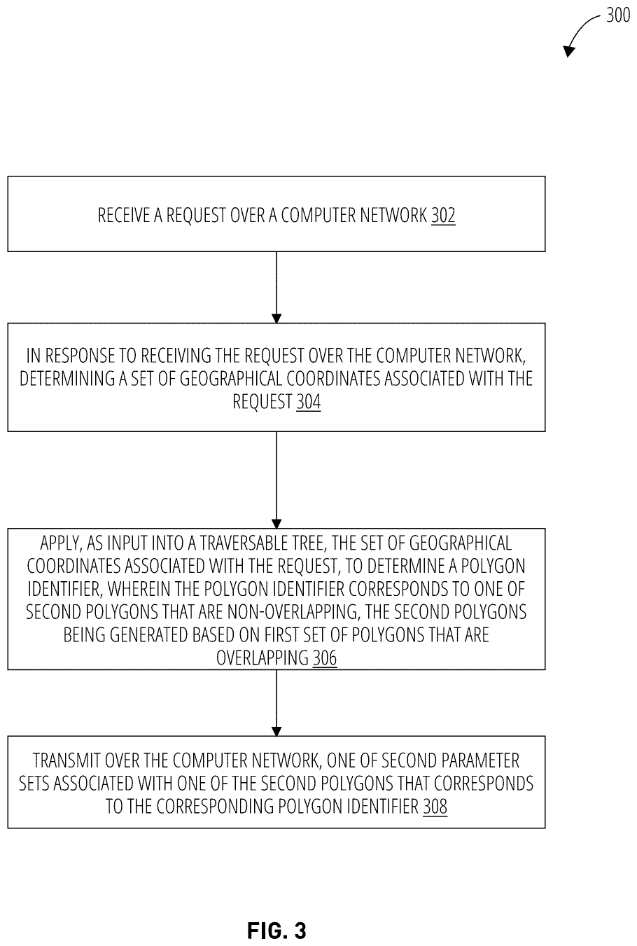

FIG. 3 shows a flow diagram of a method 300 for serving geographical-based parameters, in accordance with an embodiment. The method 300 may be performed by processing logic that may comprise hardware (circuitry, dedicated logic, etc.), software (such as is run on a general purpose computer system or a dedicated machine), firmware, or a combination. Processing logic may comprise a plurality of processors operating in a distributed computing architecture (e.g., a plurality of services that may be distributed over different servers on a computer network). Each service may be a self-contained buildable and deployable set of machine-executable instructions with dedicated computer resources such as processors, processor bandwidth, network transceiver resources, computer memory, etc. Method 300 may be performed by a data processing system as described in other figures.

At block 302, processing logic receives a request over a computer network. The request may be received by a client device over the computer network. For example, the client device may transmit the request through an API call, where the request comprises locational information (e.g., a street address, a business name, a zip code, etc.).

In an embodiment, prior to receiving the request at block 302 (e.g., during an offline processing stage), processing logic generates the second set of polygons based on the first set of polygons. Generating the second set of polygons comprises decoding data files to extract the first set of polygons, each of the data files encoding geographic information, and generating the second set of polygons according to the superimposed first set of polygons on a common reference plane. Generating the second set of polygons according to the superimposed first set of polygons includes generating additional one or more polygons for each partially overlapped first set of polygons. For example, when first polygon A overlaps with first polygon B in a common area C, this common area C is generated as its own second polygon.

By using structured geospatial data files (e.g., GeoJSON) to store the first set of polygons, processing logic leverages a reliable structure and defined data structure from which each of the first set of polygons may be stored and extracted from, while also allowing for extensibility and flexibility, each of the data files may comprise configurable fields that can be defined as needed to expand capabilities. Further, the fields of the structured geospatial data files may be predefined according to an agreed upon ordering or naming convention to improve extraction speed and correctness.

In an embodiment, each of the second set of polygons are uniquely associated with the corresponding polygon identifier and a corresponding one of the second set of parameter sets. Each of the first set of polygons comprise boundaries of a respective geographical area, where at least two or more of the first set of polygons overlap and each of the first set of polygons are associated with a corresponding one of first set of parameter sets. In such a case, the second set of parameter sets comprise a combined version of the first set of parameter sets where the first set of polygons have overlap. For example, assuming that polygon X3 is an area of overlap between first polygon X1 and first polygon X2, and first polygon X1 is associated with parameter {A}, and first polygon X2 is associated with parameters {B,D}, processing logic will generate second polygon X3 as this overlap, and generate the second set of parameter set of second polygon X3 as {A, B, D}.

Based on this ‘flattening’ of the first set of polygons to the second set of polygons, this helps to reduce the computational overhead when the client request is received over the computer network, rather, the corresponding set of second set of polygons is pre-determined for each second polygon, reducing the latency in responding to the client.

In an embodiment, prior to receiving the request (e.g., during initialization of the system when the system initially goes online), processing logic generates the traversable tree based on the second set of polygons that are non-overlapping, where generating the traversable tree comprises building the traversable tree to comprise a plurality of interconnected nodes, each of the plurality of nodes corresponding to a bound area that bounds at least one of the second set of polygons. Processing logic branches the plurality of nodes in the traversable tree based on nesting of the bound area relative to other bound areas. Processing logic configures the traversable tree to output the corresponding polygon identifier that is associated with one of the second set of polygons that the geographical coordinate resides in. For example, processing logic builds the traversable tree to take the geographical coordinate as input and traverse through the nodes, following each branch that narrows the bounding box area according to where the geographic coordinate resides, until reaching a leaf node of the traversable tree.

In an embodiment, prior to receiving the request, processing logic loads the traversable tree in local memory. Local memory may refer to a computer readable memory storage that is directly accessible by processing logic (e.g., without requiring one or more hops over the computer network).

In an embodiment, the traversable tree comprises an R-tree. Other types of balanced trees may be used, such as, for example, an M-tree. In an embodiment, each leaf node of the traversable tree corresponds to one of the second set of polygons. Processing logic may balance the traversable tree on each insertion or deletion or a node, or upon build, or a combination thereof.

In an embodiment, generating the traversable tree comprises generating each of the plurality of nodes with an expiration time. For example, each node may comprise, along with the polygon ID, an expiration time T such that when processing logic traverses the traversable tree, processing logic may filter out nodes that are older than time T, thereby ignoring each of the plurality of nodes that are expired according to the expiration time. In such a manner, processing logic may further reduce latency by narrowing down candidates when traversing the tree, and reducing the need to regenerate the traversable tree to update the nodes.

At block 304, in response to receiving the request over the computer network, processing logic determines a geographical coordinate (e.g., a set of geographical coordinates such as a latitude and longitude or other unique identifier indicating a geographical point) associated with the request.

At block 306, processing logic applies as input into a traversable tree, the geographical coordinate of the request, to determine a polygon identifier, wherein the polygon identifier corresponds to one of second set of polygons that are non-overlapping, the second set of polygons being generated based on first set of polygons that do comprise overlap.

At block 308, processing logic transmits over the computer network, one of second set of parameter sets associated with one of the second set of polygons that corresponds to the corresponding polygon identifier.

In an embodiment, processing logic may update the second set of polygons in response to a change in shape, size, or location of the first set of polygons. For example, processing logic may detect a change in a database or memory location storing the first set of polygons, and in response to detecting this change, update the second set of polygons by repeating the generation process of the second set of polygons with the changed first set of polygons. In such a manner, processing logic may keep second set of polygons updated to maintain correctness of the set of second parameters associated with each second polygon and geospatial boundaries of each second polygon, and do so in an event driven manner (when detecting change to first set of polygons) rather than when not needed.

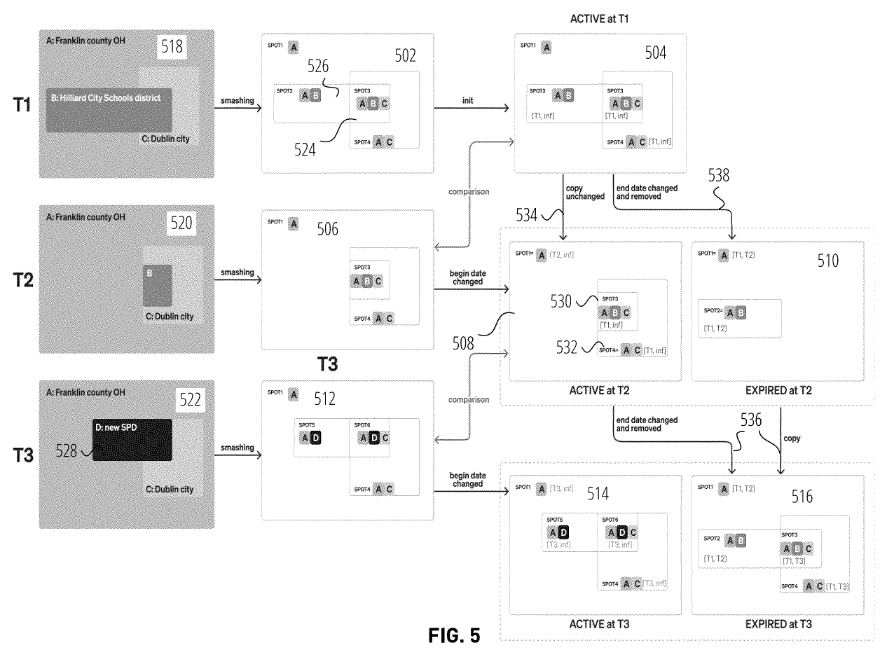

In an embodiment, updating the second set of polygons comprises generating new second set of polygons based on the change to the first set of polygons, and storing, in memory, a subset of the second set of polygons based on a difference between the second set of polygons and the new second set of polygons. See, for example, operations 534, 538, and 536 of FIG. 5. The traversable tree is updated based on the new second set of polygons. In such a manner, a record of changes may be maintained for future reference, while doing it incrementally to minimize the use of system memory and computational load.

FIG. 4 illustrates an example of generating non-overlapping second set of polygons based on first set of polygons, in accordance with an embodiment. It should be understood that in an actual application, the number of polygons may be far greater than shown in FIG. 4, and the shape of each of the polygons may comprise irregular, non-rectangular, rectangular polygons, as well as polygons with disjoint islands and holes. It should be understood that first set of polygons may, in some examples, represent any enclosed shape, which may comprise any combination or number of straight, round, or curved sides. In an embodiment, the first set of polygons may also denote a set of polygons (e.g., a collection of islands or enclosed boundaries that may share the same parameter set).

First set of polygons 416 may comprise a first polygon 402 representing geographic borders of a county, a first polygon 404 representing geographic borders of a school district, and a first polygon 406 representing geographic borders of a city. In this example, school district 404 and city 406 are completely enclosed by county 402, while a portion of school district 404 overlaps with a portion of city 406. County 402 may be associated with parameter {A}, school district 404 may be associated with parameter {B}, and city 406 may be associated with parameter {C}.

Second set of polygons 418 may be generated as a non-overlapping version of the first set of polygons 416. At regions where the first set of polygons overlap, corresponding parameters are combined. For example, second set of polygons 418 comprises a second polygon 408 which is associated only with parameter A, a second polygon 410 that is associated with parameter set {A, B}, a second polygon 412 that is associated with parameter set {A, C}, and a second polygon 414 associated with parameter set {A, B, C}. Second polygon 414 is associated with parameters {A, B, C}, because second polygon is generated as an overlapping region of county 402, school district 404 and city 406 of first set of polygons 416, and {A, B, C} is generated as a combination of the parameter sets {A}, {B}, and {C}. Second set of polygons 418 can be generated by flattening the first set of polygons 416 in a common geographical reference plane (e.g., a 2D map), and combining the parameters for each overlapping polygon.

A traversable tree 430 is generated where each of the leaf nodes (e.g., 422, 424, 426, 428) of the traversable tree may be associated with a polygon ID referring to one of the second set of polygons. Each level of nodes is associated with a bound box that bounds polygons per their location, shape, and size. Each level on a given branch contains smaller bound boxes in downstream nodes relative to a current node. Building such a data structure minimizes overlap of bound boxes in each level, which increases retrieval speed. For example, if using R-tree, the disclosed system may apply an STR algorithm to build the R-tree with these properties (e.g., minimized or reduced overlap of bound boxes).

In this example, a portion of traversable tree 430 is shown, where a node 420 represents a bound box drawn around second polygon 408. Node 422 may comprise a polygon ID that refers to polygon 408, node 424 may comprise a polygon ID that refers to second polygon 410, node 426 may comprise a polygon ID that refers to second polygon 414, and node 428 may comprise a polygon ID that refers to second polygon 412. A database may store all mappings between each parameter set and second set of polygons.

For example, a data processing system may traverse the traversable tree 430 with an input geographic coordinate 432. The traversable tree may return a polygon ID YY which is the unique identifier for second polygon 412 in which coordinate 432 lies within. A mapping may be stored in a data structure (e.g., a dictionary, key/value data structure, etc.) to retrieve the parameter set {A, C} using polygon ID YY as the lookup key.

In an embodiment, every leaf node (e.g., 428, 426, 424, 422) may comprise a valid time window [e.g., valid_from, valid_till]. The traversable tree can be configured to ignore (e.g., not traverse) nodes that are not valid for a specified time. Routine 434 illustrates an example routine for traversing the traversable tree 430. Such a routine may be called by a data processing system to traverse the traversable tree 430. The input to the routine includes coordinates (e.g., a latitude, longitude) and, optionally, a time to filter and ignore nodes that are invalid at the specified time when traversing the traversable tree 430. The tree lookup with a set of coordinates is done recursively by performing intersections starting from the root node and following the path for every intersecting bounding box. Finally reaching a set of candidate leaf nodes, which are then filtered based on time (e.g., a request time). For example, if the request time is not within a valid time range of a second polygon, the bound box of that second polygon is ignored. This tree lookup results in a set of one or more candidate leaf bounding boxes. Typically, the tree lookup results in just a single candidate leaf bounding box (corresponding to a single second polygon), but in some cases, multiple bounding boxes may be returned by traversing the tree. In such a case, the coordinates are then intersected with polygons from the second set, that correspond to candidate leaf bounding boxes, to find the final result. For example, an arrangement 436 of second polygons (polygon X and polygon Y) is shown where a set of coordinates 438 is bound within two different bound boxes (bounding polygon X and polygon Y). In such a case, the traversable tree 430 may return multiple candidates (the respective boxes bounding polygon X and polygon Y). In response, routine 434 may intersect the coordinates 438 with each of the candidate second polygons in those respective boxes, to determine which of the candidate second polygons is enclosing the coordinates 438. In this case, once the intersection of polygon X is found to enclose coordinates 438, the system may identify the polygon ID associated with that polygon X, and then retrieve the corresponding second set of parameters. If only a single bound box is returned by the traversable tree, the routine skips the intersecting operation.

FIG. 5 shows an example workflow for updating second set of polygons based on a change to first set of polygons, in accordance with an embodiment. The example workflow may be performed by a data processing system, as described in other sections herein.

Generally, a data processing system may perform updating of the second set of polygons 502, 506, 512, based on a change to the first set of polygons 518, 520, 522. A data processing system may generate respective new polygon identifiers for newly created polygons. The data processing system may store a subset of prior second set of polygons that represent a difference between the prior second set of polygons and the new second set of polygons.

At a time T1, first set of polygons 518 include three polygons representing geographic boundaries for Franklin County OH, Hilliard City Schools district, and Dublin City. In this example, Franklin County OH overlaps and encompasses both Hilliard City Schools district and Dublin City. Hilliard City Schools district and Dublin City each share an overlapping portion. Franklin county OH may be associated with a first parameter A, Hilliard City Schools district may be associated with a second parameter B, and Dublin City may be associated with a third parameter C.

The data processing system may generate second set of polygons 502, which are non-overlapping polygons using the same boundaries as those of first set of polygons 518, and with additional polygons generated from the partially overlapping polygons (e.g., second polygon 524). Each of the second set of polygons have corresponding set of second parameters that are generated by summing the overlapping first parameters. For example, second polygon 524 is associated with second set of parameters {A, B, C} because this polygon 524 comprises the sum of parameters from overlapping first set of polygons (Franklin County OH, Hilliard City Schools district, and Dublin City).

A unique polygon ID maps to each of the second set of polygons 502, and this mapping may be updated each time the first and second set of polygons are updated, so that the unique polygon ID always maps to a corresponding second polygon. The data processing system may make the second set of polygons 504 active and store these active second set of polygons 504 in memory, where upon initialization of the data processing system, the data processing system generates a traversable tree from these second set of polygons 504, as described in other sections.

From time to time, changes to first set of polygons may occur for a variety of reasons, which may be unique to the application of the data. For example, in this case, at time T2, Franklin County OH may encompass a change in Hilliard City Schools district (e.g., at time T2) and subsequent introduction of a new Special Purpose District (e.g., at time T3). For each change, the data processing system may generate new data files that contain a set of active and expired second set of polygons, based on these changes.

At time T2, one of the first set of polygons (Hilliard City Schools district) may change boundaries, as shown. First polygon data is updated to reflect the new boundaries. The data processing system may detect this change and update second set of polygons 506, either as a scheduled event, or in response to the detected change, or both. Second set of polygons 506 are updated which may include expiring second set of polygons, adding new second set of polygons, or changing boundaries of existing second set of polygons.

In this example, second polygon 526 is removed in second set of polygons 506. In an embodiment, the data processing system may compare the updated second set of polygons 506 (at time T2) to the previous version of active second set of polygons 504, to determine an expired set of second set of polygons 510. The expired set of second set of polygons 510 may represent only those second set of polygons that the data processing system deprecated when generating the update. Data processing system may, at operation 538, store these expired polygons 510 in memory, to maintain an accurate record of changes to the first and second set of polygons and to support historical lookups. Data processing system may, at operation 534, copy the unchanged second set of polygons into memory and set those as active at time T2, so that those second set of polygons 508 are used to generate an updated traversable tree.

At time T3, the first set of polygons 522 undergo a new addition of the special school district 528. The data processing system generates new second set of polygons 512 and compares the new second set of polygons 512 to the active second set of polygons 508. Based on this comparison, the data processing system detects that second polygon 530 and second set of polygons 532 have both changed (e.g., in shape, location, or size). The data processing system may, at operation 536, generate deprecated second set of polygons 516 by copying the previously deprecated second set of polygons 510 to a new common reference, and merging the newly deprecated polygons 508 to this new common reference. Similarly, this system can be used to map changes with respect to jurisdictions, counties, or other boundary lines which demarcate corresponding tax rules. By combining flattening the overlapping set of polygons to non-overlapping polygons, and then building the traversable tree to retrieve the associated parameter set for a point location in the non-overlapping tax boundaries, the system can quickly retrieve those tax rules combining parameters for overlapping regions on-the-fly, thereby reducing latency and improving efficiency in calculating taxes in a payment system that spans multiple tax jurisdictions.

By generating the deprecated second set of polygons in this incremental manner and leveraging the previously stored deprecated second set of polygons, the data processing system can reduce the computational load to capture each change to the first and second set of polygons. The data processing system stores an active version of second set of polygons 514 in memory, which then is used to generate the traversable tree.

With this approach every polygon ID always maps to a corresponding unique second polygon, and can have a format with semantic meaning. The data processing system can merge two versions of second set of polygons (e.g., at operation 534, or at operation 536) by comparing each of the second polygon areas for every second polygon ID.

In an example, to reduce the memory usage footprint for expired polygons and potential lookup latency increase, the data processing system may limit a number of deprecated polygons that are stored in memory. In an embodiment, the data processing system may treat some first set of polygons with different rules. For example, the data processing system may treat all counties separately—unincorporated county areas are typically the largest first polygon areas. The data processing system may change only a corresponding polygon (on the county level), only when a first polygon inside the county level polygon has an update. Additionally, in an embodiment, to reduce the memory footprint, some of the expired polygons are stored on server filesystem or remote memory storage and loaded on demand when requested for parameters in the past. This would make a tradeoff between memory and latency. In an embodiment, the system may configure this storage of past parameters based on the usage patterns. For example, if the clients rarely do requests in the far past (e.g. less than a threshold amount or frequency of such requests), those expired polygons can be loaded on demand, with a drawback of lower latency.

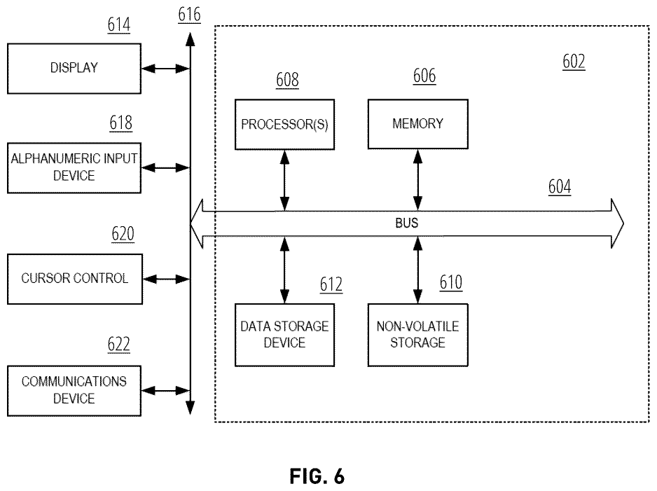

FIG. 6 is one embodiment of a computer system that may be used to support the systems and operations described, in accordance with an embodiment. For example, the computer system illustrated in FIG. 6 may represent a data processing system, as described in the various sections. It will be apparent to those of ordinary skill in the art, however that other alternative systems of various system architectures may also be used.

The computer system 602 illustrated in FIG. 6 includes a bus or other internal communication means 604 for communicating information, and one or more processors 608 coupled to the bus 604 for processing information. The system further comprises a random access memory (RAM) or other volatile storage device 606 (referred to as memory), coupled to bus 604 for storing information and instructions to be executed by processor 608. Main memory 606 also may be used for storing temporary variables or other intermediate information during execution of instructions by processor 608. The system also comprises a read only memory (ROM), non-volatile storage, and/or static storage device 610 coupled to bus 604 for storing static information and instructions for processor 608, and a data storage device 612 such as a magnetic disk or optical disk and its corresponding disk drive. Data storage device 612 is coupled to bus 604 for storing information and instructions.

The system may further be coupled to a display device 614, such as a light emitting diode (LED) display or a liquid crystal display (LCD) coupled to bus 604 through bus 616 for displaying information to a computer user. An alphanumeric input device 618, including alphanumeric and other keys, may also be coupled to bus 604 through bus 616 for communicating information and command selections to processor 608. An additional user input device is cursor control device 620, such as a touchpad, mouse, a trackball, stylus, or cursor direction keys coupled to bus 604 through bus 616 for communicating direction information and command selections to processor 608, and for controlling cursor movement on display device 614.

Another device, which may optionally be coupled to computer system 602, is a communication device 622 for accessing other nodes of a distributed system via a network. The communication device 622 may include any of a number of commercially available networking peripheral devices such as those used for coupling to an Ethernet, token ring, Internet, or wide area network. The communication device 622 may further be a null-modem connection, or any other mechanism that provides connectivity between the computer system 602 and the outside world. Note that any or all of the components of this system illustrated in FIG. 6 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 606, mass storage device 612, or other storage medium locally or remotely accessible to processor 608.

It will be apparent to those of ordinary skill in the art that the system, method, and process described herein can be implemented as software stored in main memory 606 or read only memory and executed by processor 608. This control logic or software may also be resident on an article of manufacture comprising a computer readable medium having computer readable program code embodied therein and being readable by the mass storage device 612 and for causing the processor 608 to operate in accordance with the methods and teachings herein.

The embodiments discussed herein may also be embodied in a handheld or portable device containing a subset of the computer hardware components described above. For example, the handheld device may be configured to contain only the bus 604, the processor 608, and memory 606 and/or 612. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 608, a data storage device 612, a bus 604, and memory 606, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A method performed by a data processing system, comprising:
receiving a request over a computer network;
in response to receiving the request over the computer network, determining a set of geographical coordinates associated with the request;
applying as input into a traversable tree, the set of geographical coordinates associated with the request, to determine a polygon identifier, wherein the polygon identifier corresponds to one of a second set of polygons that are non-overlapping, the second set of polygons being generated based on a first set of polygons that are overlapping; and
transmitting over the computer network, one of second parameter sets associated with one of the second set of polygons that corresponds to the corresponding polygon identifier.

2. The method of claim 1, further comprising:
prior to receiving the request,
generating the second set of polygons based on the first set of polygons, comprising:
decoding data files to extract the first set of polygons, wherein each of the data files encodes geographic information, and
generating the second set of polygons according to the first set of polygons being arranged on a common reference plane.

3. The method of claim 2, wherein each of the second set of polygons are uniquely associated with the corresponding polygon identifier and a corresponding one of the second parameter sets, wherein each of the first set of polygons comprise boundaries of a respective geographical area, wherein at least two or more of the first set of polygons overlap and each of the first set of polygons are associated with a corresponding one of a first parameter sets, and wherein the second parameter sets comprise a combined version of the first parameter sets where the first set of polygons are overlapping.

4. The method of claim 1, further comprising:
prior to receiving the request,
generating the traversable tree based on the second set of polygons that are non-overlapping, comprising:
building the traversable tree with a plurality of nodes, each of the plurality of nodes corresponding to a bound area that bounds at least one of the second set of polygons,
branching the plurality of nodes in the traversable tree based on nesting of the bound area relative to other bound areas, and
configuring the traversable tree to output the corresponding polygon identifier that is associated with one of the second set of polygons that the set of geographical coordinates resides in.

5. The method of claim 4, further comprising:
prior to receiving the request, loading the traversable tree in local memory of the data processing system.

6. The method of claim 4, wherein each leaf node of the traversable tree corresponds to one of the second set of polygons.

7. The method of claim 4, wherein generating the traversable tree comprises generating each of the plurality of nodes with a valid time window, and traversing the traversable tree comprises filtering the traversable tree to ignore each of the plurality of nodes that are expired according to time specified in the request and the valid time window.

8. The method of claim 1, further comprising:
updating the second set of polygons in response to a change in shape, size, or location of the first set of polygons.

9. The method of claim 8, wherein updating the second set of polygons comprises:
generating new second set of polygons based on the change to the first set of polygons, and
storing, in memory, a subset of the second set of polygons based on a difference between the second set of polygons and the new second set of polygons, wherein the traversable tree is updated based on the new second set of polygons.

10. A server computer system comprising:
a memory, and one or more processors coupled with the memory configured to perform operations, comprising:
receiving a request over a computer network;
in response to receiving the request over the computer network, determining a set of geographical coordinates associated with the request;
applying as input into a traversable tree, the set of geographical coordinates associated with the request, to determine a polygon identifier, wherein the polygon identifier corresponds to one of second set of polygons that are non-overlapping, the second set of polygons being generated based on first set of polygons that are overlapping; and
transmitting over the computer network, one of second parameter sets associated with one of the second set of polygons that corresponds to the corresponding polygon identifier.

11. The server computer system of claim 10, wherein the operations further comprise:
prior to receiving the request,
generating the second set of polygons based on the first set of polygons, comprising:
decoding data files to extract the first set of polygons, wherein each of the data files encodes geographic information, and
generating the second set of polygons according to the first set of polygons being arranged on a common reference plane.

12. The server computer system of claim 11, wherein each of the second set of polygons are uniquely associated with the corresponding polygon identifier and a corresponding one of the second parameter sets, wherein each of the first set of polygons comprise boundaries of a respective geographical area, wherein at least two or more of the first set of polygons overlap and each of the first set of polygons are associated with a corresponding one of first parameter sets, and wherein the second parameter sets comprise a combined version of the first parameter sets where the first set of polygons are overlapping.

13. The server computer system of claim 10, wherein the operations further comprise:
prior to receiving the request,
generating the traversable tree based on the second set of polygons that are non-overlapping, comprising:
building the traversable tree with a plurality of nodes, each of the plurality of nodes corresponding to a bound area that bounds at least one of the second set of polygons,
branching the plurality of nodes in the traversable tree based on nesting of the bound area relative to other bound areas, and
configuring the traversable tree to output the corresponding polygon identifier that is associated with one of the second set of polygons that the set of geographical coordinates resides in.

14. The server computer system of claim 13, wherein the operations further comprise:
prior to receiving the request, loading the traversable tree in local memory.

15. The server computer system of claim 13, wherein the traversable tree comprises an R-tree, and wherein each leaf node of the traversable tree corresponds to one of the second set of polygons.

16. A non-transitory computer readable storage medium storing instructions, which when executed by a computer processing system, causes the computer processing system to perform operations comprising:
receiving a request over a computer network;
in response to receiving the request over the computer network, determining a set of geographical coordinates associated with the request;
applying as input into a traversable tree, the set of geographical coordinates associated with the request, to determine a polygon identifier, wherein the polygon identifier corresponds to one of second set of polygons that are non-overlapping, the second set of polygons being generated based on first set of polygons that are overlapping; and
transmitting over the computer network, one of second parameter sets associated with one of the second set of polygons that corresponds to the corresponding polygon identifier.

17. The non-transitory computer readable storage medium of claim 16, wherein the operations further comprise:
prior to receiving the request,
generating the second set of polygons based on the first set of polygons, comprising:
decoding data files to extract the first set of polygons, wherein each of the data files encodes geographic information, and
generating the second set of polygons according to the first set of polygons being arranged on a common reference plane.

18. The non-transitory computer readable storage medium of claim 17, wherein each of the second set of polygons are uniquely associated with the corresponding polygon identifier and a corresponding one of the second parameter sets, wherein each of the first set of polygons comprise boundaries of a respective geographical area, wherein at least two or more of the first set of polygons overlap and each of the first set of polygons are associated with a corresponding one of first parameter sets, and wherein the second parameter sets comprise a combined version of the first parameter sets where the first set of polygons are overlapping.

19. The non-transitory computer readable storage medium of claim 16, wherein the operations further comprise:
prior to receiving the request,
generating the traversable tree based on the second set of polygons that are non-overlapping, comprising:
building the traversable tree with a plurality of nodes, each of the plurality of nodes corresponding to a bound area that bounds at least one of the second set of polygons,
branching the plurality of nodes in the traversable tree based on nesting of the bound area relative to other bound areas, and
configuring the traversable tree to output the corresponding polygon identifier that is associated with one of the second set of polygons that the set of geographical coordinates resides in.

20. The non-transitory computer readable storage medium of claim 19, wherein the operations further comprise:
prior to receiving the request, loading the traversable tree in local memory.
